(19) United States
(12) Patent Application Publication
(10) Pub. No.: US 2020/0050219 A1
(43) Pub. Date: Feb. 13, 2020

(54) UAV CONTROL METHOD, FLIGHT CONTROLLER AND UAV

(71) Applicant: SZ DJI TECHNOLOGY CO., LTD., Shenzhen (CN)

(72) Inventors: Liang SONG, Shenzhen (CN); Ning JIANG, Shenzhen (CN); Haofei WANG, Shenzhen (CN)

(21) Appl. No.: 16/654,769

(22) Filed: Oct. 16, 2019

Related U.S. Application Data
(63) Continuation of application No. PCT/CN2017/080967, filed on Apr. 18, 2017.

(51) Int. Cl. G05D 1/10; G08G 5/00; B64C 39/02

(52) U.S. Cl. CPC G05D 1/106; B64C 2201/12; B64C 39/024; G08G 5/0039

(57) ABSTRACT

The present disclosure provides an Unmanned Aerial Vehicle (UAV) control method. The method includes the steps of acquiring a current flight direction of the UAV in real time; acquiring a current detection direction of a detection sensor mounted on the UAV in real time; calculating an angular difference between the current flight direction and the current detection direction; and adjusting the current detection direction based on the angular difference.

### CROSS-REFERENCE TO RELATED APPLICATION

This application is a continuation application of International Application No. PCT/CN2017/080967, filed on Apr. 18, 2017, the entire content of which is incorporated herein by reference.

### TECHNICAL FIELD

The present disclosure relates to the field of Unmanned Aerial Vehicles (UAV), and more specifically, to a UAV control method, a flight controller, and a UAV.

### BACKGROUND

In conventional technology, a UAV is generally equipped with a detection sensor to detect obstacles to accomplish obstacle avoidance. However, the detection sensor is generally fixed directly in front of the UAV, and the range of the detection angle may be limited. When the UAV is not moving in the forward direction, but at a certain offset angle, an obstacle may not be detected because the route range in the flight direction may exceed the effective detection range of the detection sensor. As such, the obstacle avoidance function may fail.

### SUMMARY

One aspect of the present disclosure provides an UAV control method. The method includes the steps of acquiring a current flight direction of the UAV in real time; acquiring a current detection direction of a detection sensor mounted on the UAV in real time; calculating an angular difference between the current flight direction and the current detection direction; and adjusting the current detection direction based on the angular difference.

Another aspect of the present disclosure provides a flight controller of an UAV, the UAV having a mounted detection sensor. The flight controller includes a flight direction acquisition unit for acquiring a current flight direction of the UAV in real time; a detection direction acquisition unit for acquiring a current detection direction of the detection sensor in real time; an angle calculation module for calculating an angular difference between the current flight direction and the current detection direction; and a sensor adjustment module for adjusting the current detection direction based on the angular difference.

Another aspect of the present disclosure provides a flight controller of an UAV, the UAV having a mounted detection sensor. The flight controller is configured to execute instructions to: acquire a current flight direction of the UAV in real time; acquire a current detection direction of the detection sensor in real time; calculate an angular difference between the current flight direction and the current detection direction; and adjust the current detection direction based on the angular difference.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flowchart illustrating a method of controlling a UAV according to an embodiment of the present disclosure.

FIG. 2 is a block diagram illustrating a flight controller according to an embodiment of the present disclosure.

FIG. 3 is a block diagram illustrating the UAV according to an embodiment of the present disclosure.

FIG. 4 is a flowchart illustrating a method of controlling the UAV according to another embodiment of the present disclosure.

FIG. 5 is a block diagram illustrating the flight controller according to another embodiment of the present disclosure.

FIG. 6 is a block diagram illustrating the UAV according to another embodiment of the present disclosure.

FIG. 7 is a flowchart illustrating a method of controlling the UAV according to yet another embodiment of the present disclosure.

FIG. 8 is a flowchart illustrating a method of controlling the UAV according to still another embodiment of the present disclosure.

FIG. 9 is a block diagram illustrating the flight controller according to yet another embodiment of the present disclosure.

FIG. 10 is a block diagram illustrating the UAV according to yet another embodiment of the present disclosure.

FIG. 11 is a flowchart illustrating a method of controlling the UAV according to another embodiment of the present disclosure.

FIG. 12 is a block diagram illustrating the flight controller according to another embodiment of the present disclosure.

FIG. 13 is a block diagram illustrating the UAV according to another embodiment of the present disclosure.

FIG. 14 is a flowchart illustrating a method of controlling the UAV according to yet another embodiment of the present disclosure.

FIG. 15 is a block diagram illustrating the flight controller according to yet another embodiment of the present disclosure.

FIG. 16 is a block diagram illustrating the UAV according to yet another embodiment of the present disclosure.

FIG. 17 is a block diagram illustrating the flight controller according to still another embodiment of the present disclosure.

FIG. 18 is a plan view illustrating the UAV according to an embodiment of the present disclosure.

FIG. 19 is a plan view illustrating the UAV according to another embodiment of the present disclosure.

FIG. 20 is a plan view illustrating the UAV according to yet another embodiment of the present disclosure.

FIG. 21 is a plan view illustrating the UAV according to still another embodiment of the present disclosure.

### DESCRIPTION OF THE REFERENCE NUMERALS

100 UAV
10 Flight controller
11 Initialization module
12 Flight direction acquisition unit
13 Detection direction acquisition unit
14 Angle calculation module
15 Sensor adjustment module
16 Information acquisition module
17 Flight adjustment module
172 Rotational speed calculation unit
174 Rotational speed acquisition unit
176 Rotational speed output unit
178 Rotation controller
1782 Reception subunit
1784 Controller subunit
20 Detection sensor
30 Inertial measurement unit
40 First electronic governor
50 Second electronic governor
60 Power assembly
70 Actuator
72 Stator
74 Rotor
80 Body
90 Frame
200 Remote controller

### DETAILED DESCRIPTION OF THE EMBODIMENTS

Reference will now be made in detail to exemplary embodiments, examples of which are illustrated in the accompanying drawings, in which the same or similar reference numbers throughout the drawings represent the same or similar elements or elements having same or similar functions. Embodiments described below with reference to drawings are merely examples and used for explaining the present disclosure, and should not be understood as limitation to the present disclosure.

In the description of the present disclosure, it should be understood that the terms “first,”, “second,” etc. are only used to indicate different components, but do not indicate or imply the order, the relative importance, or the number of the components. Further, in the description of the present disclosure, unless otherwise specified, the term “first,” or “second” preceding a feature explicitly or implicitly indicates one or more of such feature.

In the present disclosure, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements or interactions of two elements, which can be understood by those skilled in the art according to specific situations.

Various embodiments and examples are provided in the following description to implement different structures of the present disclosure. In order to simplify the present disclosure, certain elements and settings will be described. However, these elements and settings are only examples and are not intended to limit the present disclosure. In addition, reference numerals may be repeated in different examples in the disclosure. This repeating is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

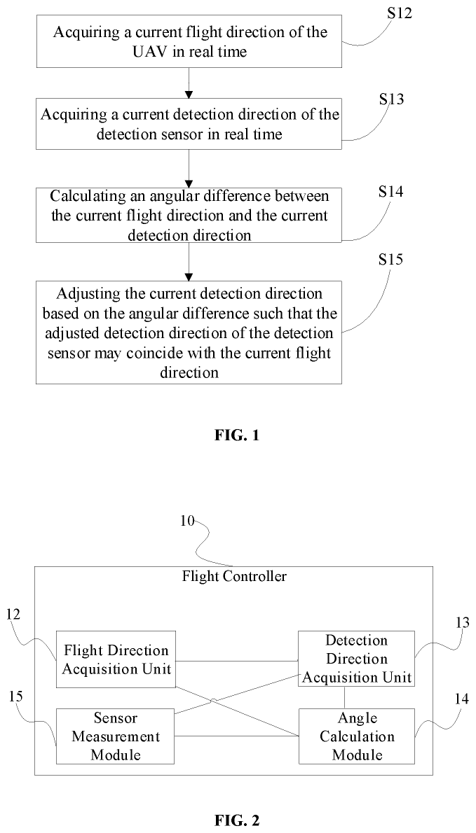

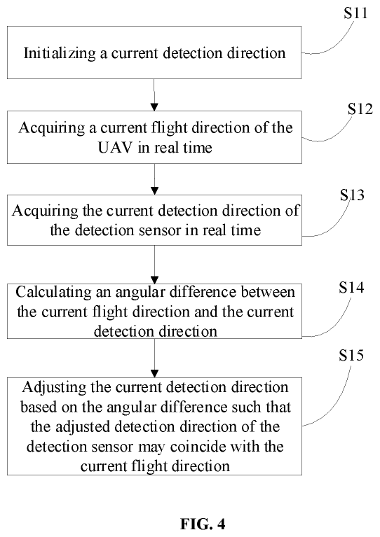

Referring to FIG. 1 and FIG. 3, a method for controlling a UAV 100 consistent with embodiments of the present disclosure is provided and the UAV 100 includes a detection sensor 20 mounted on the UAV 100. The method is described in more detail below.

S12, acquiring a current flight direction of the UAV 100 in real time.

S13, acquiring a current detection direction of the detection sensor 20 in real time.

S14, calculating an angular difference between the current flight direction and the current detection direction.

S15, adjusting the current detection direction based on the angular difference such that the adjusted detection direction of the detection sensor 20 may coincide with the current flight direction.

The control method of the UAV 100 of the embodiments of the present disclosure may be realized by a flight controller 10 of the embodiments of the present disclosure.

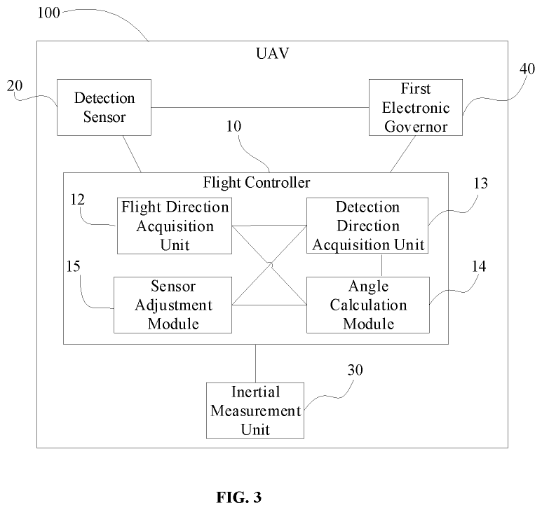

Referring to FIG. 2, the flight controller 10 of the embodiments of the present disclosure may be used to control the UAV 100. The UAV 100 is equipped with the detection sensor 20, and the flight controller 10 includes a flight direction acquisition unit 12, a detection direction acquisition unit 13, an angle calculation module 14, and a sensor adjustment module 15. The flight direction acquisition unit 12 may be configured to acquire the current flight direction of the UAV 100 in real time. The detection direction acquisition unit 13 may be configured to acquire the current detection direction of the detection sensor 20 in real time. The angle calculation module 14 may be configured to calculate the angular difference between the current flight direction and the current detection direction. The sensor adjustment module 15 may be configured to adjust the current detection direction based on the angular difference such that the adjusted detection direction of the detection sensor 20 may coincide with the current flight direction.

That is, S12 may be implemented by the flight direction acquisition unit 12, S13 may be implemented by the detection direction acquisition unit 13, S14 may be implemented by the angle calculation module 14, and S15 may be implemented by the sensor adjustment module 15.

The flight controller 10 of the present disclosure may also be applied to the UAV 100 of the present disclosure. That is, the UAV 100 of the present disclosure may include the flight controller 10 of the present disclosure. Referring FIG. 3, the UAV 100 further includes the detection sensor 20, an Inertial Measurement Unit (IMU) 30, and a first electronic governor 40. The IMU 30 may be configured to detect the current flight direction of the UAV 100. The flight controller 10 is connected to the IMU 30 and the first electronic governor 40 through a wired or a wireless communication connection.

In embodiments of the present disclosure, according to the control method of the UAV 100, the flight controller 10, and the UAV 100 may be rotated in various directions by using the detection sensor 20, and the adjusted detection direction of the detection sensor 20 may consistently coincide with the current flight direction. As such, when the UAV 100 is in flight, the detection range of the detection sensor 20 may consistently cover the route range of the current flight direction of the UAV 100. Therefore, obstacles in the flight direction of the UAV 100 may be effectively detected, and collision with the obstacles may be prevented from causing a flight accident.

In one embodiment, during the flight of the UAV 100, S12, S13, S14, and S15 may be performed continuously and cyclically. It may be understood that in the process of adjusting the detection direction of the detection sensor 20, there may be a process of real-time feedback and adjustment of the detecting direction. That is, the flight direction acquisition unit 12 may acquire the current flight direction of the UAV 100 in real time; the detection direction acquisition unit 13 may acquire the current detection direction of the detection sensor 20 in real time; the angle calculation module 14 may calculate the angular difference between the current flight direction and the current detection direction; and the sensor adjustment module 15 may adjust the current detection direction based on the angular difference such that the adjusted detection direction of the detection sensor 20 may coincide with the current flight direction and the transmit the adjusted detection direction to the detection direction acquisition unit 13. As such, the adjusted detection direction of the previous cycle may be the current detection direction of the next cycle, and the angle calculation module 14 may calculate the angular difference between the current flight direction and the current detection direction again, and so on.

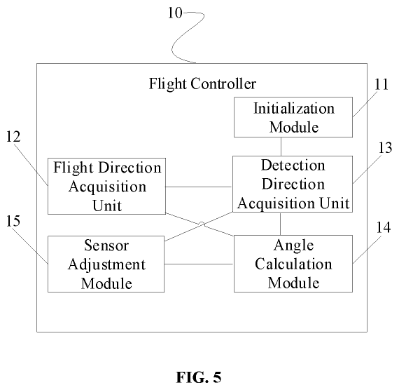

Referring to FIG. 4. In some embodiments, the control method further includes S11, initializing the current detection direction.

Referring to FIG. 5. In some embodiments, the flight controller 10 further includes an initialization module 11. The initialization module 11 may be configured to initialize the current detection direction.

That is, S11 may be implemented by the initialization module 11.

When the current detection direction is initialized or calibrated, the subsequent adjustment of the current detection direction may be more accurate and errors may be reduced, which may further ensure that the adjusted detection direction is consistent with the current flight direction, thereby effectively detecting the obstacles in the flight direction of the UAV 100 and avoiding collision accidents and causing flight accidents.

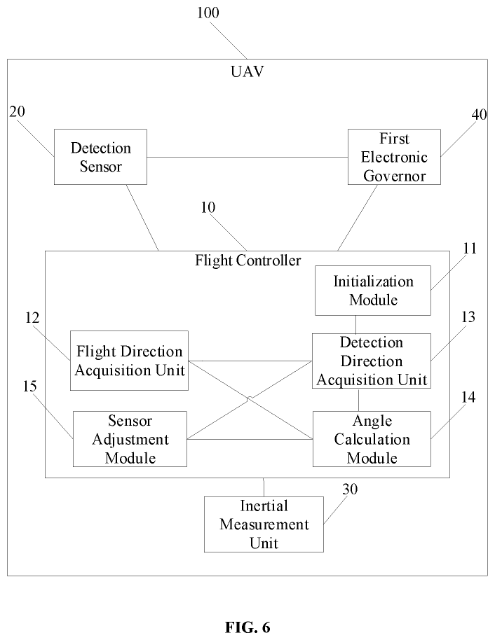

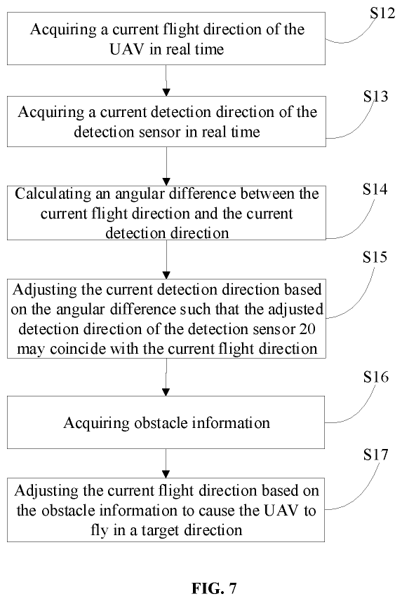

Referring to FIG. 6. In some embodiments, the flight controller 10 in the UAV 100 further includes the initialization module 11 for initializing the current detection direction.

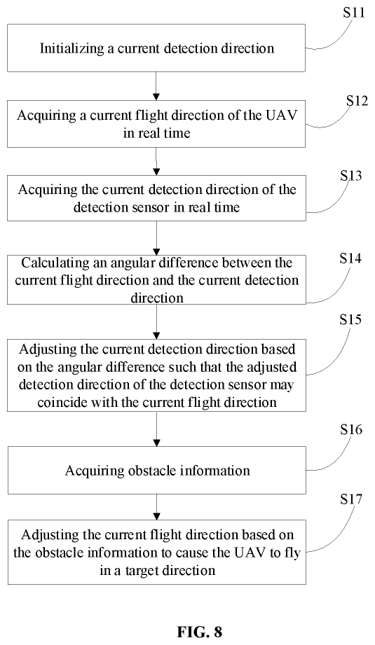

Referring to FIG. 7 and FIG. 8. In some embodiments, the detection sensor 20 may be an obstacle detection sensor 20 for detecting obstacle information, and the obstacle information may include whether or not an obstacle is present in the flight environment of the UAV 100. The control method is described in more below.

S16, acquiring obstacle information.

S17, adjusting the current flight direction based on the obstacle information to cause the UAV 100 to fly in a target direction.

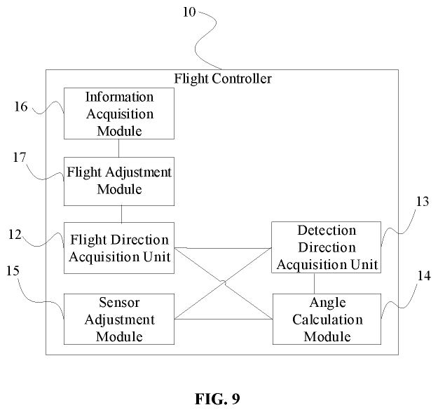

Referring to FIG. 9. In some embodiments, the flight controller 10 further includes an information acquisition module 16 and a flight adjustment module 17. The information acquisition module 16 may be configured to acquire the obstacle information. The flight adjustment module 17 may be configured to adjust the current flight direction based on the obstacle information to cause the UAV 100 to fly in the target direction.

That is, S16 may be implemented by the information acquisition module 16 and S17 may be implemented by the flight adjustment module 17.

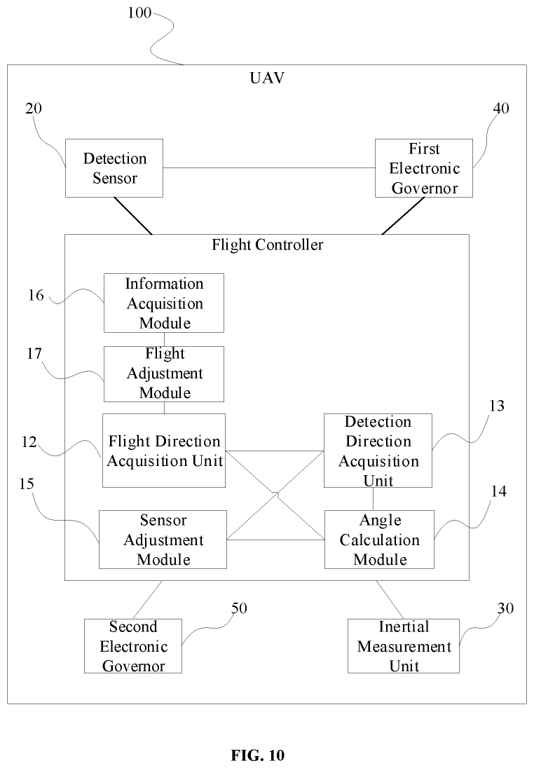

Referring to FIG. 10. In some embodiments, the UAV further includes a second electronic governor 50. The flight adjustment module 17 may control the second electronic governor 50 to adjust the current flight direction based on the obstacle information to cause the UAV 100 to fly in the target direction. That is, S17 may be implemented by the flight adjustment module 17 controlling the second electronic governor 50.

Accordingly, the detection sensor 20 may acquire the obstacle information in real time and cause the UAV 100 to adjust the current flight direction in real time to avoid obstacles, thereby ensuring the safety of the UAV 100 and avoiding a flight accident caused by the collision obstacle.

In one embodiment, during the flight of the UAV 100, S16 and S17 may be performed continuously and cyclically. That is, the detection sensor 20 may consistently detect obstacle information in real time, and the flight adjustment module 17 may control the second electronic governor 50 to adjust the current flight direction in real time based on the obstacle information to cause the UAV 100 to fly based on the target flight direction. Further, it may be understood that the target direction may be the flight direction of which the UAV 100 may avoid the obstacle.

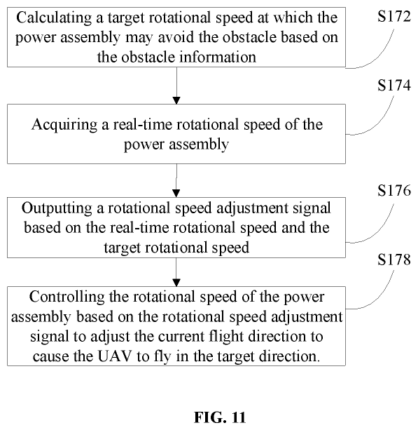

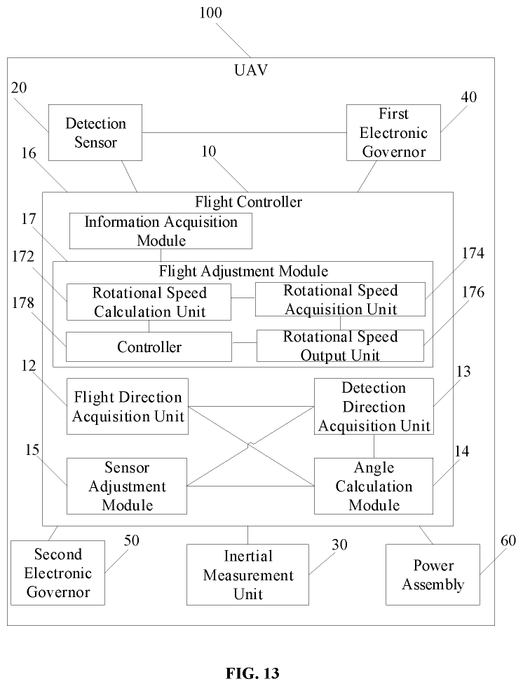

Referring to FIG. 11 and FIG. 13. In some embodiments, the UAV 100 further includes a power assembly 60. The power assembly may be used to drive the UAV 100 to fly. S17 is described in more detail below.

S172, calculating a target rotational speed at which the power assembly 60 may avoid the obstacle based on the obstacle information.

S174, acquiring a real-time rotational speed of the power assembly 60.

S176, outputting a rotational speed adjustment signal based on the real-time rotational speed and the target rotational speed.

S178, controlling the rotational speed of the power assembly 60 based on the rotational speed adjustment signal to adjust the current flight direction to cause the UAV 100 to fly in the target direction.

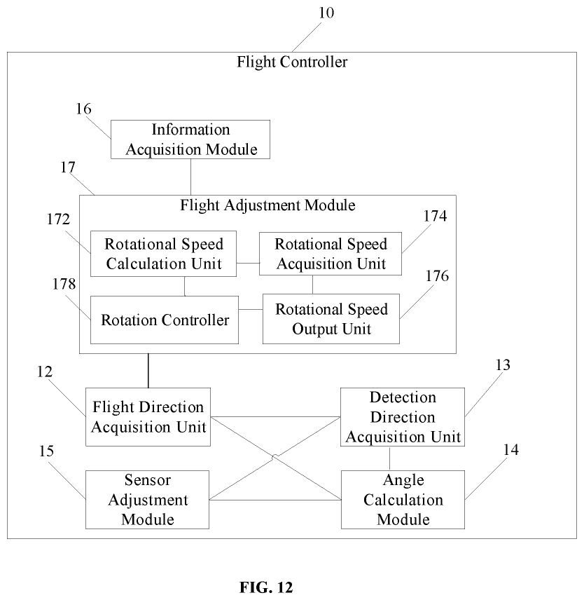

Referring to FIG. 12. In some embodiments, the flight adjustment module 17 includes a rotational speed calculation unit 172, a rotational speed acquisition unit 174, a rotational speed output unit 176, and a rotation controller 178. The rotational speed calculation unit 172 may be configured to calculate the target rotational speed at which the power assembly 60 may avoid the obstacle based on the obstacle information. The rotational speed acquisition unit 174 may be configured to acquire the real-time rotational speed of the power assembly 60. The rotational speed output unit 176 may be configured to output the rotational speed adjustment signal based on the real-time rotational speed and the target rotational speed. The controller 178 may be configured to control the rotational speed of the power assembly 60 based on the rotational speed adjustment signal to adjust the current flight direction to cause the UAV 100 to fly in the target direction.

That is, S172 may be implemented by the rotational speed calculation unit 172, S174 may be implemented by the rotational speed acquisition unit 174, S176 may be implemented by the rotational speed output unit 176, and S178 may be implemented by the controller 178.

Referring to FIG. 13 again. In some embodiments, the UAV 100 further includes the power assembly 60. The power assembly 60 may be used to drive the UAV 100 to fly, and the controller 178 may be configured to control the second electronic governor 50 to adjust the rotational speed of the power assembly 60 based on the rotational speed adjustment signal to adjust the current flight direction to cause the UAV 100 to fly in the target direction. That is, S178 may be implemented by the controller 178 controlling the second electronic governor 50 to adjust the power assembly 60.

Accordingly, the rotational speed of the power assembly 60 may be adjusted in real time based on the obstacle information to avoid obstacles. Therefore, the obstacle avoidance speed may be quick, and the flight process of the UAV 100 may be more secure.

In one embodiment, during the flight of the UAV 100, S172, S174, S176, and S178 may be performed continuously and cyclically. It may be understood that in the process of adjusting the flight direction of the UAV 100, there may be a process of real-time feedback and adjustment of the power assembly 60. That is, the rotational speed calculation unit 172 may calculate the target rotational speed at which the power assembly 60 may avoid the obstacle based on the obstacle information, the rotational speed acquisition unit 174 may acquire the real-time rotational speed of the power assembly 60 in real time, the rotational speed output unit 176 may output the rotational speed adjustment signal based on the real-time rotational speed and the target rotational speed, and the control 178 may control the second electronic governor 50 to adjust the rotational speed of the power assembly 60 based on the rotational speed adjustment signal to adjust the current flight direction to cause the UAV 100 to fly in the target direction, and then feed the adjusted real-time rotational speed to the rotational speed calculation unit 172. Subsequently, the rotational speed calculation unit 172 may output a new target rotational speed based on the real-time rotational speed and the target rotational speed to form a cyclic process.

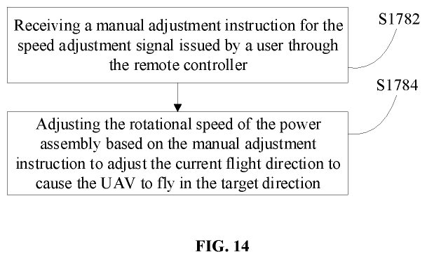

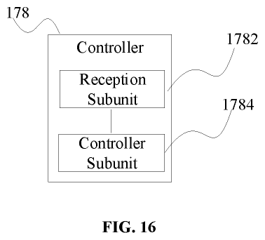

Referring to FIG. 14 and FIG. 16. In some embodiments, the UAV is controlled by a remote controller 200. S178 is described in more detail below.

S1782, receiving a manual adjustment instruction for the speed adjustment signal issued by a user through the remote controller 200.

S1784, adjusting the rotational speed of the power assembly 60 based on the manual adjustment instruction to adjust the current flight direction to cause the UAV 100 to fly in the target direction.

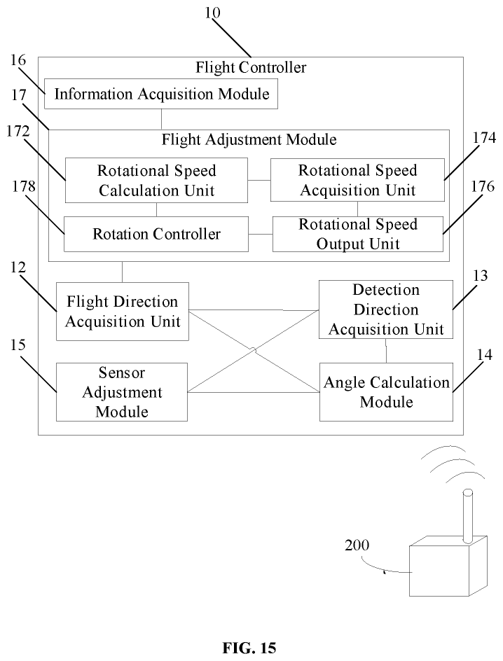

Referring to FIG. 15 and FIG. 16. In some embodiments, the controller 178 includes a reception subunit 1782 and a controller subunit 1784. The reception subunit 1782 may be configured to receive the manual adjustment instruction for the speed adjustment signal issued by the user through the remote controller 200. The controller subunit 1784 may be configured to adjust the rotational speed of the power assembly 60 based on the manual adjustment instruction to adjust the current flight direction to cause the UAV 100 to fly in the target direction.

That is, S1782 may be implemented by the reception subunit 1782, and S 1784 may be implemented by the controller subunit 1784.

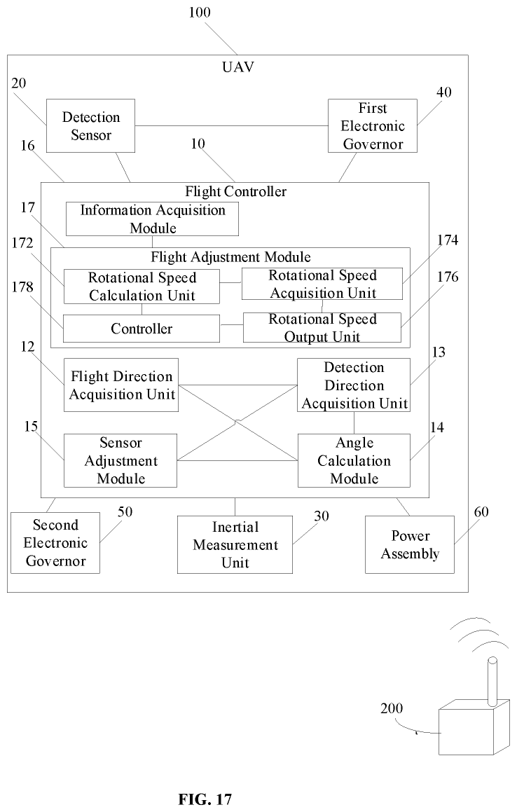

Referring to FIG. 16 and FIG. 17. In some embodiments, the UAV 100 is controlled by the remote controller 200, and the flight controller 10 in the UAV 100 includes the reception subunit 1782 and the controller subunit 1784. The reception subunit 1782 may be configured to receive the manual adjustment instruction for the speed adjustment signal issued by the user through the remote controller 200. The controller subunit 1784 may be configured to adjust the rotational speed of the power assembly 60 based on the manual adjustment instruction to adjust the current flight direction to cause the UAV 100 to fly in the target direction.

Accordingly, the user may control the obstacle avoidance process of the UAV 100 through the remote controller 200. When the user identifies an obstacle, the flight direction of the UAV 100 may be adjusted in time to avoid the obstacle.

In one embodiment, the rotational speed output unit 176 may transmit the rotational speed adjustment signal to the remote controller 200. When the remote controller 200 receives the rotational speed adjustment signal, the user may manually issue the manual remote control instruction to the remote controller 200. Subsequently, the remote controller 200 may transmit manual remote control instruction to the reception subunit 1782. The controller 178 may control the second electronic governor 50 to adjust the rotational speed of the power assembly 60 based on the manual remote control instruction received by the reception subunit 1782 to adjust the current flight direction to cause the UAV 100 to fly in the target direction.

In some embodiments, the UAV 100 may include the flight controller 10 that may be used to control the flight of the UAV 100, and S178 may be automatically performed by the flight controller 10.

In some embodiments, in the flight controller 10, the controller 178 may automatically control the rotational speed of the power assembly 60 based on the rotational speed adjustment signal to control the adjustment of the current flight direction to cause the UAV 100 to fly in the target direction.

In some embodiments, in the UAV 100, the controller 178 may automatically control the second electronic governor 50 to adjust the rotational speed of the power assembly 60 based on the rotational speed adjustment signal to adjust the current flight direction to cause the UAV 100 to fly in the target direction.

Accordingly, a user operation may not be required, and the obstacle avoidance process of the UAV 100 may be automated, which may enhance the user experience.

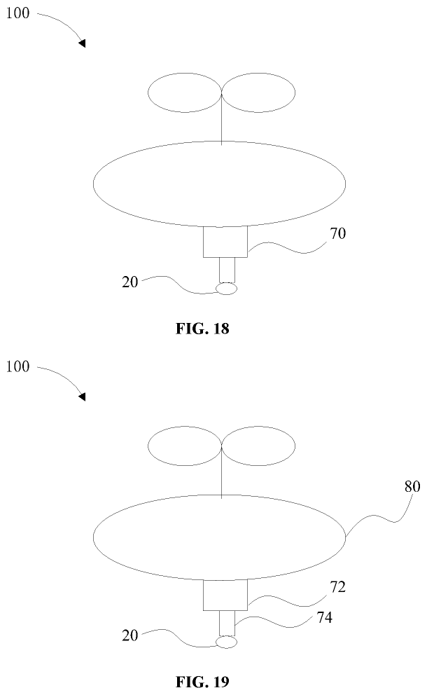

Referring to FIG. 18. In some embodiments, the UAV 100 further includes an actuator 70. The actuator 70 may be used to drive the detection sensor 20, and the actuator 70 may be electrically connected to the first electronic governor 40. The first electronic governor 40 may adjust the current detection direction by adjusting the rotational speed of the actuator 70.

Accordingly, the detection sensor 20 may be driven by a separate actuator 70 to facilitate the adjustment of the current detection direction of the detection sensor 20 to coincide with the current flight direction of the UAV 100.

Referring to FIG. 19. In some embodiments, the UAV 100 further includes a body 80 and the actuator 70 includes a stator 72 and a rotor 74. The stator may be fixedly connected to the body 80, and the detection sensor 20 may be mounted on the rotor 74.

Accordingly, the detection sensor 20 may be mounted on the rotor 74, and the rotation of the rotor 74 may cause the detection sensor 20 to rotate, such that the current detection direction of the detection sensor 20 may coincide with the current flight direction of the UAV 100.

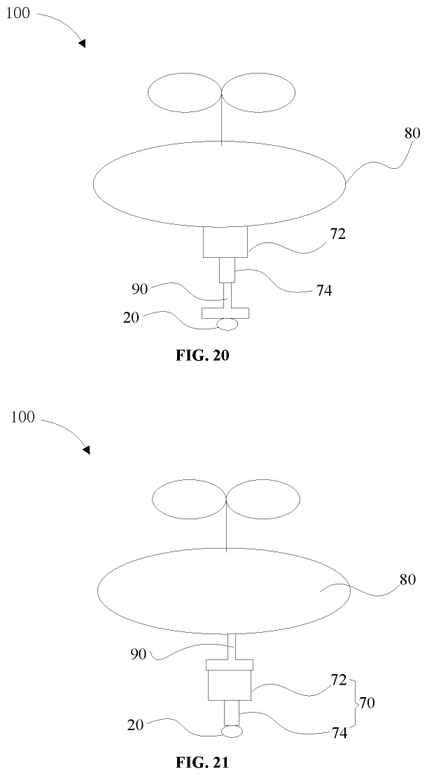

Referring to FIG. 20. In some embodiments, the UAV 100 further includes a frame 90. The frame may be fixedly connected to the rotor 74, and the detection sensor 20 may be mounted on the frame 90.

Accordingly, the detection sensor 20 may be connected to the rotor 74 through the frame 90, and the detection sensor 20 may be carried on the frame 90 to make the mounting of the detection sensor 20 more stable.

In one embodiment, the frame 90 may be a hallow frame 90. As such, the weight of the frame 90 may be reduced, and weight of the payload of the UAV 100 may also be reduced.

Referring to FIG. 21. In some embodiments, the UAV 100 further includes the frame 90. The frame 90 may be fixedly connected to the body 80, and the actuator 70 may include the stator 72 and the rotor 74. The stator may be fixedly connected to the frame 90, and the detection sensor 20 may be mounted on the rotor 74.

Accordingly, the actuator 70 may be connected to the body 80 through the frame 90, and the actuator 70 may be mounted on the frame 90 such that the mounting of the actuator 70 may be more stable.

In some embodiments, the detection sensor 20 may include any one or a combination of a binocular vision sensor, an ultrasound sensor, or an infrared sensor.

It may be understood that the UAV 100 of the embodiments of the present disclosure may be mounted with any one of a binocular vision sensor, an ultrasound sensor, and an infrared sensor. In one embodiment, the UAV 100 may be mounted with both the binocular vision sensor and the ultrasonic sensor; the ultrasonic sensor and the infrared sensor; or the binocular vision sensor and the infrared sensor. In another embodiment, the UAV 100 may be mounted with the binocular vision sensor, the ultrasonic sensor, and the infrared sensor.

Referring to FIG. 3, the flight controller 10 of the embodiments of the present disclosure may be mounted on the UAV 100, and the detection sensor 20 may be mounted on the UAV 100. The flight controller 10 may be configured to execute the following instructions.

Acquiring the current flight direction of the UAV 100 in real time; acquiring the current detection direction of the detection sensor 20 in real time; calculating the angular difference between the current flight direction and the current detection direction; and adjusting the current detection direction based on the angular difference such that the adjusted detection direction of the detection sensor 20 may coincide with the current flight direction.

The flight controller 10 of the embodiments of the present disclosure may be rotated in various directions by using the detection sensor 20, and the adjusted detection direction of the detection sensor 20 may consistently coincide with the current flight direction. As such, when the UAV 100 is in flight, the detection range of the detection sensor 20 may consistently cover the route range of the current flight direction of the UAV 100. Therefore, obstacles in the flight direction of the UAV 100 may be effectively detected, and collision with the obstacles may be prevented from causing a flight accident.

In one embodiment, during the flight of the UAV 100, there may be a process of real-time feedback and adjustment of the detecting direction when adjusting the detection direction of the detection sensor 20. That is, the flight controller 10 may be configured to acquire the current flight direction of the UAV 100 and the current detection direction of the detection sensor 20 in real time, and calculate the angular difference between the current flight direction and the current detection direction. Further, the flight controller 10 may be configured to adjust the current detection direction based on the angular difference such that the adjusted detection direction of the detection sensor 20 may coincide with the current flight direction. As such, the adjusted detection direction of the previous cycle may be the current detection direction of the next cycle, and the flight controller 10 may be configured to calculate the angular difference between the current flight direction and the current detection direction again, and so on.

Referring to FIG. 6. In some embodiments, the flight controller 10 may be configured to execute the following instruction.

Initializing the current detection direction.

When the current detection direction is initialized or calibrated, the subsequent adjustment of the current detection direction may be more accurate and errors may be reduced, which may further ensure that the adjusted detection direction is consistent with the current flight direction, thereby effectively detecting the obstacles in the flight direction of the UAV 100 and avoiding collision accidents and causing flight accidents.

Referring to FIG. 10. In some embodiments, the detection sensor 20 mounted on the UAV 100 may be an obstacle detection sensor 20 for detecting obstacle information, and the obstacle information may include whether or not an obstacle is present in the flight environment of the UAV 100. The flight controller 10 may be configured to execute the following instructions.

Acquiring obstacle information; and adjusting the current flight direction based on the obstacle information to cause the UAV 100 to fly in the target direction.

As such, the detection sensor 20 may acquire the obstacle information in real time and cause the UAV 100 to adjust the current flight direction in real time to avoid obstacles, thereby ensuring the safety of the UAV 100 and avoiding a flight accident caused by the collision obstacle.

In one embodiment, during the flight of the UAV 100, the detection sensor 20 may constantly detect obstacle information in real time. The UAV 100 may further include the second electronic governor 50, and the flight controller 10 may continuously control the rational speed of the second electronic governor 50 in real time based on the obstacle information to adjust the current flight direction to cause the UAV 100 to fly according to the target flight direction. Further, it may be understood that the target direction may be the flight direction of which the UAV 100 may avoid the obstacle.

Referring to FIG. 13. In some embodiments, the UAV 100 further includes the power assembly 60. The power assembly may be used to drive the UAV 100 to fly. The flight controller 10 may be configured to execute the following instructions.

Calculating a target rotational speed at which the power assembly 60 may avoid the obstacle based on the obstacle information; acquiring a real-time rotational speed of the power assembly 60; outputting the rotational speed adjustment signal based on the real-time rotational speed and the target rotational speed; and controlling the rotational speed of the power assembly 60 based on the rotational speed adjustment signal to adjust the current flight direction to cause the UAV 100 to fly in the target direction.

Accordingly, the rotational speed of the power assembly 60 may be adjusted in real time based on the obstacle information to avoid obstacles. Therefore, the obstacle avoidance speed may be quick, and the flight process of the UAV 100 may be more secure.

In one embodiment, in the process of adjusting the flight direction of the UAV 100, there may be a process of real-time feedback and adjustment of the power assembly 60. That is, the flight controller 10 may be configured to calculate the target rotational speed at which the power assembly 60 may avoid the obstacle based on the obstacle information, and acquire the real-time rotational speed of the power assembly 60 in real time. Subsequently, the rotational speed adjustment signal may be outputted based on the real-time rotational speed and the target rotational speed, and the second electronic governor 50 may be controlled to adjust the rotational speed of the power assembly 60 based on the rotational speed adjustment signal to adjust the current flight direction to cause the UAV 100 to fly in the target direction. Thereafter, a new target rotational speed may be outputted based on the real-time rotational speed and the target rotational speed of the previous cycle to form a cyclic process.

Referring to FIG. 17. In some embodiments, the UAV 100 is controlled by the remote controller 200. The flight controller 10 may be configured to execute the following instructions.

Receiving a manual adjustment instruction for the speed adjustment signal issued by a user through the remote controller 200; and adjusting the rotational speed of the power assembly 60 based on the manual adjustment instruction to adjust the current flight direction to cause the UAV 100 to fly in the target direction.

As such, the user may control the obstacle avoidance process of the UAV 100 through the remote controller 200. When the user identifies an obstacle, the flight direction of the UAV 100 may be adjusted in time to avoid the obstacle.

In one embodiment, the flight controller 10 may transmit the rotational speed adjustment signal to the remote controller 200. When the remote controller 200 receives the rotational speed adjustment signal, the user may manually issue the manual remote control instruction to the remote controller 200. Subsequently, the remote controller 200 may transmit manual remote control instruction to the flight controller 10. The flight controller 10 may control the rotational speed of the power assembly 60 based on the received manual remote control instruction received to adjust the current flight direction to cause the UAV 100 to fly in the target direction.

The UAV 100 of the embodiments of the present disclosure may be applied to, but is not limited to, performing various tasks in the fields of electric power, communication, meteorology, agriculture, oceanography, exploration, photography, disaster prevention and mitigation, crop estimation, smuggling prevention, border patrol, security, and counter-terrorism.

Referring to FIG. 3, the UAV 100 of the embodiments of the present disclosure may include the flight controller 10, the detection sensor 20, the IMU 30, and the first electronic governor 40 described in any of the previous embodiments. The IMU 30 may be used to detect the current flight direction of the UAV 100. The flight controller 10 may be connected to the IMU 30 and the first electronic governor 40.

The UAV 100 of the embodiments of the present disclosure may be rotated in various directions by using the detection sensor 20, and the adjusted detection direction of the detection sensor 20 may consistently coincide with the current flight direction. As such, when the UAV 100 is in flight, the detection range of the detection sensor 20 may consistently cover the route range of the current flight direction of the UAV 100. Therefore, obstacles in the flight direction of the UAV 100 may be effectively detected, and collision with the obstacles may be prevented from causing a flight accident.

Referring to FIG. 10. In some embodiments, the UAV 100 further includes the second electronic governor 50. The flight controller 10 may control the second electronic governor 50 to adjust the current flight direction based on the obstacle information to cause the UAV 100 to fly in the target direction.

Referring to FIG. 13. In some embodiments, the UAV 100 further includes the power assembly 60. The power assembly 60 may be used to drive the UAV 100 to fly. In one embodiment, the flight controller 10 may control the second electronic governor 50 to adjust the rotational speed of the power assembly 100 based on the rotational speed adjustment signal to adjust the current flight direction to cause the UAV 100 to fly in the target direction.

Referring to FIG. 17. In some embodiments, the UAV 100 is controlled by the remote controller 200.

In some embodiments of the UAV 100, the flight controller 10 may automatically control the second electronic governor 50 to adjust the rotational speed of the power assembly 100 based on the rotational speed adjustment signal to adjust the current flight direction to cause the UAV 100 to fly in the target direction.

Referring to FIG. 18. In some embodiments, the UAV 100 further includes the actuator 70. The actuator 70 may be used to drive the detection sensor 20, and the actuator 70 may be electrically connected to the first electronic governor 40. The first electronic governor 40 may adjust the current detection direction by adjusting the rotational speed of the actuator 70.

Accordingly, the detection sensor 20 may be driven by a separate actuator 70 to facilitate the adjustment of the current detection direction of the detection sensor 20 to coincide with the current flight direction of the UAV 100.

Referring to FIG. 19. In some embodiments, the UAV 100 further includes the body 80 and the actuator 70 includes the stator 72 and the rotor 74. The stator may be fixedly connected to the body 80, and the detection sensor 20 may be mounted on the rotor 74.

Accordingly, the detection sensor 20 may be mounted on the rotor 74, and the rotation of the rotor 74 may cause the detection sensor 20 to rotate, such that the current detection direction of the detection sensor 20 may coincide with the current flight direction of the UAV 100.

Referring to FIG. 20. In some embodiments, the UAV 100 further includes the frame 90. The frame may be fixedly connected to the rotor 74, and the detection sensor 20 may be mounted on the frame 90.

Accordingly, the detection sensor 20 may be connected to the rotor 74 through the frame 90, and the detection sensor 20 may be carried on the frame 90 to make the mounting of the detection sensor 20 more stable.

In one embodiment, the frame 90 may be a hallow frame 90. As such, the weight of the frame 90 may be reduced, and weight of the payload of the UAV 100 may also be reduced.

Referring to FIG. 21. In some embodiments, the UAV 100 further includes the frame 90. The frame 90 may be fixedly connected to the body 80, and the actuator 70 may include the stator 72 and the rotor 74. The stator may be fixedly connected to the frame 90, and the detection sensor 20 may be mounted on the rotor 74.

Accordingly, the actuator 70 may be connected to the body through the frame 90, and the actuator 70 may be mounted on the frame 90 such that the mounting of the actuator 70 may be more stable.

In some embodiments, the detection sensor 20 may include any one or a combination of a binocular vision sensor, an ultrasound sensor, or an infrared sensor. In one example, the detection sensor 20 may be a binocular vision sensor, an ultrasound sensor, or an infrared sensor. In another example, the detection sensor 20 may be a combination of a binocular vision sensor and an ultrasonic sensor, a combination of an ultrasonic sensor and an infrared sensor, or a combination of a binocular vision sensor and an infrared sensor. In yet another example, the detection sensor 20 may be a combination of a binocular vision sensor, an ultrasound sensor, and an infrared sensor.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. In this specification, exemplary descriptions of aforesaid terms are not necessarily referring to the same embodiment or example. Furthermore, the particular features, structures, materials, or characteristics may be combined in any suitable manner in one or more embodiments or examples. Moreover, those skilled in the art could combine different embodiments or different characteristics in embodiments or examples described in the present disclosure.

Moreover, terms such as “first” and “second” are only used for description and cannot be seen as indicating or implying relative importance or indicating or implying the number of the indicated technical features. Thus, the features defined with “first” and “second” may comprise or imply at least one of these features. In the description of the present disclosure, “a plurality of” means two or more than two, unless specified otherwise.

Although embodiments of present disclosure have been shown and described above, it should be understood that above embodiments are just explanatory, and cannot be construed to limit the present disclosure, for those skilled in the art, changes, alternatives, and modifications can be made to the embodiments without departing from spirit, principles and scope of the present disclosure.

What is claimed is:

1. An Unmanned Aerial Vehicle (UAV) control method comprising:
acquiring a current flight direction of the UAV in real time;
acquiring a current detection direction of a detection sensor mounted on the UAV in real time;
calculating an angular difference between the current flight direction and the current detection direction; and
adjusting the current detection direction based on the angular difference.

2. The method of claim 1, further comprising:
initializing the current detection direction.

3. The method of claim 1, wherein:
the detection sensor is an obstacle detection sensor for detecting obstacle information, and the obstacle information includes whether an obstacle is in a flight environment of the UAV; and the method further includes:
acquiring the obstacle information; and
adjusting the current flight direction based on the obstacle information to fly the UAV in a target direction.

4. The method of claim 3, wherein:
the UAV includes a power assembly for driving the UAV; and
adjusting the current flight direction based on the obstacle information to fly the UAV in the target direction includes:
calculating a target rotational speed needed for the power assembly to avoid the obstacle based on the obstacle information;
acquiring a real-time rotational speed of the power assembly;
outputting a rotational speed adjustment signal based on the real-time rotational speed and the target rotational speed; and
adjusting a rotational speed of the power assembly based on the rotational speed adjustment signal to adjust the current flight direction to fly the UAV in the target direction.

5. The method of claim 4, wherein:
the UAV is controlled by a remote controller; and
adjusting the rotational speed of the power assembly based on the rotational speed adjustment signal to adjust the current flight direction to fly the UAV in the target direction includes:
receiving a manual adjustment instruction to the remote controller; and
adjusting the rotational speed of the power assembly based on the manual adjustment instruction to adjust the current flight direction.

6. The method of claim 4, wherein:
the UAV further includes a flight controller for controlling the flight of the UAV; and
adjusting the rotational speed of the power assembly based on the rotational speed adjustment signal to adjust the current flight direction to fly the UAV in the target direction is automatically performed by the flight controller.

7. A flight controller of an Unmanned Aerial Vehicle (UAV), the UAV having a mounted detection sensor, the flight controller comprising:
a flight direction acquisition unit for acquiring a current flight direction of the UAV in real time;
a detection direction acquisition unit for acquiring a current detection direction of the detection sensor in real time;
an angle calculation module for calculating an angular difference between the current flight direction and the current detection direction; and
a sensor adjustment module for adjusting the current detection direction based on the angular difference.

8. The flight controller of claim 7, further includes:
an initialization module for initializing the current detection direction.

9. The flight controller of claim 7, wherein:
the detection sensor is an obstacle detection sensor for detecting obstacle information, and the obstacle information includes whether an obstacle is in a flight environment of the UAV; and the flight controller further includes:
an information acquisition module for acquiring the obstacle information; and
a flight adjustment module for adjusting the current flight direction based on the obstacle information to fly the UAV in a target direction.

10. The flight controller of claim 9, wherein:
the UAV includes a power assembly for driving the UAV; and
the flight adjustment module includes:
a rotational speed calculation unit for calculating a target rotational speed needed for the power assembly to avoid the obstacle based on the obstacle information;
a rotational speed acquisition unit for acquiring a real-time rotational speed of the power assembly;
a rotational speed output unit for outputting a rotational speed adjustment signal based on the real-time rotational speed and the target rotational speed; and
a rotation controller for adjusting a rotational speed of the power assembly based on the rotational speed adjustment signal to adjust the current flight direction to fly the UAV in the target direction.

11. The flight controller of claim 10, wherein:
the UAV is controlled by a remote controller; and
the rotation controller includes:
a reception subunit for receiving a manual adjustment instruction to the remote controller for the rotational speed adjustment signal; and
a controller subunit for adjusting the rotational speed of the power assembly based on the manual adjustment instruction to adjust the current flight direction to fly the UAV in the target direction.

12. The flight controller of claim 10, wherein:
The rotation controller automatically adjusts the rotational speed of the power assembly based on the rotational speed adjustment signal to fly the UAV in the target direction.

13. A flight controller of an Unmanned Aerial Vehicle (UAV), the UAV having a mounted detection sensor, the flight controller being configured to execute instructions to:
acquire a current flight direction of the UAV in real time;
acquire a current detection direction of the detection sensor in real time;
calculate an angular difference between the current flight direction and the current detection direction; and
adjust the current detection direction based on the angular difference.

14. The flight controller of claim 13, wherein the flight controller is further configured to execute the instructions to:
initializing the current detection direction.

15. The flight controller of claim 13, wherein:
the detection sensor is an obstacle detection sensor for detecting obstacle information, and the obstacle information includes whether an obstacle is in a flight environment of the UAV; and the flight controller is further configured to execute the instructions to:
acquire the obstacle information; and
adjust the current flight direction based on the obstacle information to fly the UAV in a target direction.

16. The flight controller of claim 15, wherein:
the UAV includes a power assembly for driving the UAV; and
the flight controller is further configured to execute the instructions to:
calculate a target rotational speed needed for the power assembly to avoid the obstacle based on the obstacle information;
acquire a real-time rotational speed of the power assembly;
output a rotational speed adjustment signal based on the real-time rotational speed and the target rotational speed; and
adjust a rotational speed of the power assembly based on the rotational speed adjustment signal to adjust the current flight direction to fly the UAV in the target direction.

17. The flight controller of claim 16, wherein:
the UAV is controlled by a remote controller; and
the flight controller is further configured to execute the instructions to:
receive a manual adjustment instruction to the remote controller for the rotational speed adjustment signal; and
adjust the rotational speed of the power assembly based on the manual adjustment instruction to fly the UAV in the target direction.
